(19) United States
(12) Patent Application Publication
(10) Pub. No.: US 2011/0084194 A1
(43) Pub. Date: Apr. 14, 2011

(54) CASSETTE FOR BIOLOGICAL ANALYSIS AND METHOD OF MAKING THEREOF

(75) Inventors: Pierre Sévigny, Montreal (CA); Christopher Burry, Ste-Marthe-sur-le-Lac (CA); Shamee Patil, Morris Plains, NJ (US)

(73) Assignee: DGel Sciences, Montreal (CA)

(21) Appl. No.: 12/886,870

(22) Filed: Sep. 21, 2010

Related U.S. Application Data
(60) Provisional application No. 61/245,430, filed on Sep. 24, 2009.
(60) Provisional application No. 61/328,205, filed on Apr. 27, 2010.

(51) Int. Cl. B29C 33/20

(52) U.S. Cl. 249/160; 249/117

(57) ABSTRACT

It is described a sealed cassette for molding a composition used for biological analysis having a first opening for introducing the composition and a second opening for contacting the composition. The sealed cassette further comprises a stopper removably mounted onto the cassette to seal the second opening. Another cassette comprises a first shell and a second shell. The first shell and the second shell are adapted for mating together in a first respective position keeping a first distance between the first shell and the second shell and for mating together in a second respective position keeping a second distance between the first shell and the second shell. The first and second shells, when mated together, are adapted to receive the composition. Methods for making such cassettes are also described.

### TECHNICAL FIELD

This description relates to the field of biological analysis devices. More particularly, this description relates to cassettes for molding a gel.

### BACKGROUND

One of the most widely analytical procedures used in biotechnology is gel electrophoresis for the separation of proteins, peptides and nucleic acids from complex or purified samples. Such procedures used a sheet of gel generally molded in a reusable cassette. The cassette is filled with a liquid composition, usually an acrylamide or agarose composition, which polymerizes, then forming a gel.

An encountered problem with cassettes is that the material in which the cassette is made of, can react with the gel. In this case, the gel is no more pure and can distort the analysis. It also creates severe cosmetic problems. Also, the plastic contains and traps oxygen, which inhibits the polymerization reaction of the gel, which diminishes the efficiency and functionality of the gel.

Two types of other problems are encountered with the gel in cassettes and especially with acrylamide composition. A first type comprises problems of accelerated aging of the gel. The second type comprises problems of swirls appearing at the surface of the gel after the polymerization against the cassette's plastic surface. When swirls appear, the gel is less adhesive to the cassette's plastic surface, sometimes tends to separate from the cassette's surface. Variability between gels is also noticeable, which affect the reliability of the technique. Conditions of occurrence of these two phenomena remain unknown. Researches were often directed toward the composition of the liquid to polymerize as opposed to the cassette. To date there exist no solution for a cassette that would overcome these drawbacks.

Cassettes have two openings for contacting the gel during the analysis. In case of electrophoresis, one opening allows contact to the gel by an anode, the other by a cathode. One of the openings is used for filling the cassette with the liquid composition. The second opening must then be sealed. Generally, users unsuccessfully cobble patch to seal the second opening. Then, a portion of the fluid composition runs out of the cassette and forms gel on the support.

Moreover, these analyses require several thicknesses of sheet of gel. Now, laboratories which conduct these analyses have to store and manage several types of cassettes.

There is therefore a need for improved cassettes for biological analysis.

### SUMMARY

It is an object of the present disclosure to provide cassette that overcomes or mitigates one or more disadvantages of known cassettes or at least provides a useful alternative.

According to an embodiment, there is provided a sealed cassette for molding a composition used for biological analysis, the sealed cassette comprising:

a cassette for receiving the composition, the cassette having:
a diametrically opposed first opening and second opening and

a stopper removably mounted onto the cassette to seal the first or second opening.

Optionally, the stopper comprises:
a mechanical layer for retaining the composition; and
an adhesive layer covering a portion of the mechanical layer and adhering to the cassette for sealing the second opening.

The sealed may comprise a gel retaining member. The gel retaining member may be at least one wall partially obstructing the first or second opening.

The at least one wall may be obstructing from about 50% to about 99% of the first or second opening.

The sealed cassette may comprise at least one well separator receiving groove therein, adapted to receive and hold a well separator.

The sealed cassette may comprise a plurality of well separator receiving grooves therein, adapted to receive and hold a well separator.

The sealed cassette may comprise at least two well separator receiving grooves therein, facing each other and adapted to receive and hold a well separator.

The sealed cassette may comprise a plurality of well separator receiving grooves therein, facing each other and adapted to receive and hold a well separator.

Optionally, the sealed cassette comprises a first shell and a second shell removably fixed together.

Optionally, the removably fixing comprises welding or gluing.

According to another embodiment, there is provided a method for sealing an opening of a cassette used for biological analysis, the method comprising:

a) removably mounting a stopper onto the cassette to seal the opening.

Optionally, the step a) comprises:

dipping a mechanical layer in a sealing liquid; and

mounting the coated mechanical layer onto the cassette to seal the opening.

According to another embodiment, there is provided a cassette for molding a composition used for biological analysis, the cassette comprising:

a first shell; and

a second shell;

wherein the first shell and the second shell are adapted for mating together in a first respective position keeping a first distance between the first shell and the second shell and for mating together in a second respective position keeping a second distance between the first shell and the second shell, and

wherein the first and second shells, when mated together, define a cavity adapted to receive the composition having a diametrically opposed first and second opening.

Optionally, the first shell comprises at least one peg and the second shell comprises an internal surface having at least one cavity with a bottom;

wherein when the shells are mated in the first position, the at least one peg abuts to the internal surface of the second shell for keeping the first distance; and

wherein when the shells are mated in the second position, the at least one peg abuts to the at least one cavity bottom for keeping the second distance.

The cassette may comprise a gel retaining member. The gel retaining member may be at least one wall obstructing the first or second opening.

The gel retaining member may be a plurality of walls obstructing the first or second opening.

The obstruction of the first or second opening may be from about 50% to about 99%.

The at least one wall may be attached to any one of the first shell or the second shell.

The plurality of wall may be attached to any one of the first shell or the second shell.

The at least one well separator receiving groove therein may be adapted to receive and hold a well separator.

The cassette may comprise a plurality of well separator receiving grooves therein, adapted to receive and hold a well separator.

The cassette may comprise at least two well separator receiving grooves therein, diametrically opposed and adapted to receive and hold a well separator.

The cassette may comprise a plurality of well separator receiving grooves therein, facing each other and adapted to receive and hold a well separator.

Optionally, the first shell and the second shell are removably fixed together.

Optionally, the removably fixing comprises welding or gluing.

According to another embodiment, there is provided a cassette for molding an acrylamide composition used for biological analysis, the cassette made of a plastic selected from the group consisting of Eastman SPECTAR copolyester™ PETG, EASTAR copolyesters™ AN004, DuraStar polymer™ MN611, EASTAR copolyesters™ DN004, EASTAR copolyesters™ DN011, Eastman TRITAN copolyester™ TX1001, EASTAR copolyesters™ EN067, EASTAR copolyesters™ 6763, EASTAR copolyesters™ 21446 and EASTAR PCTG copolyesters™.

Optionally, any of previously described cassettes further comprise a coating to form a chemical barrier between the plastic and the acrylamide composition, the coating comprising a silanic layer coating the plastic.

### BRIEF DESCRIPTION OF THE DRAWINGS

Further features and advantages of the present invention will become apparent from the following detailed description, taken in combination with the appended drawings, in which:

FIG. 1 is a picture of a cassette before and after the sealing, according an embodiment;

FIG. 2 is a axonometric view of a cassette according to another embodiment in which the two shells can be mated in two different positions at two different space apart distances;

FIGS. 3A-3D are partial cutting views of the cassette of FIG. 2, in the two different positions.

FIGS. 4A-D are axonomic views of cassette shells according to embodiments of the present invention with gel retaining members;

FIGS. 5A-B are axonomic views of cassettes shells according to embodiments of the present invention with well separator receiving grooves.

It will be noted that throughout the appended drawings, like features are identified by like reference numerals.

### DETAILED DESCRIPTION

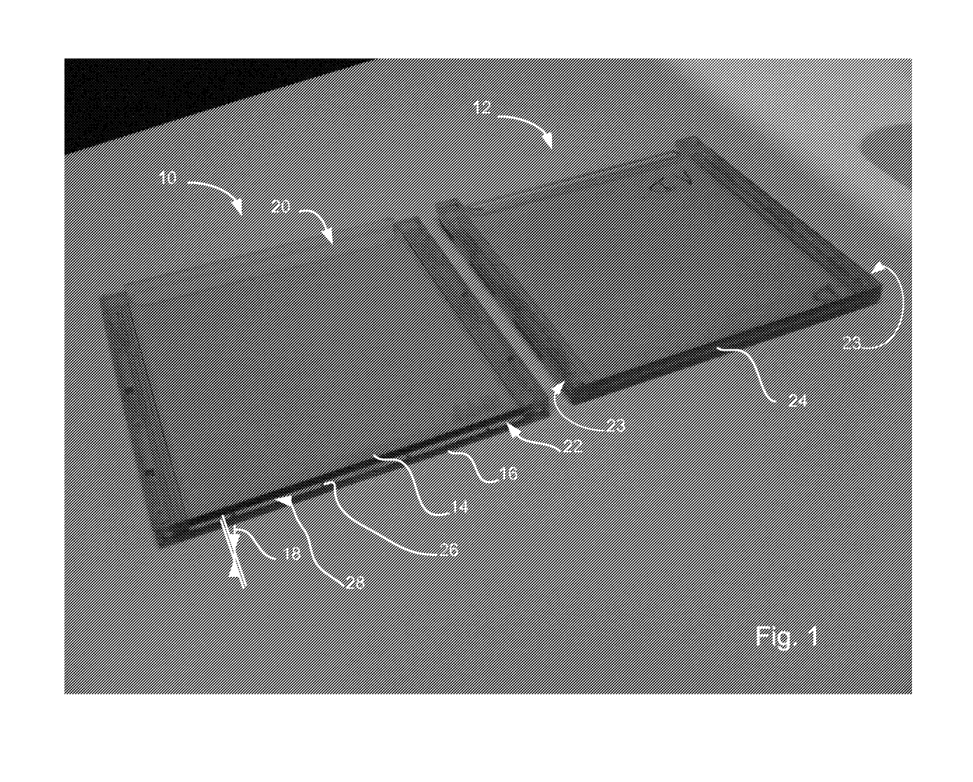

Referring now to the drawings, and more particularly to FIG. 1, a picture shows a cassette 10 before the sealing and a sealed cassette 12 after the sealing. The cassette 10 comprises a first shell 14 and a second shell 16. The first shell 14 and the second shell 16 are adapted for mating together in a respective position keeping a distance 18 between the first shell 14 and the second shell 16. The first and second shells 14 & 16, when mated together as shown, are adapted to receive a liquid composition, not shown. The cassette 10 further comprises a first opening 20 and a second opening 22. One of the openings 20 & 22 is use for introducing the liquid composition in the cassette 10. The openings 20 & 22 are for contacting the polymerized liquid composition, namely a gel, during the analysis.

Experiments were conducted to understand the phenomena of accelerated aging of the gel and of folding of the surface of the gel. It was discovered that with a given acrylamide composition, different surfaces of gel were obtained depending on the type and characteristic of the cassette's material, preferably plastic. Any others conditions being fixed, with a first plastic the surface of the gel is flat and adhesive with a second plastic the surface of the gel is pleated and tends to slide. It was also discovered that more the plastic is charged more the surface of the molded gel is pleated. Moreover, it was discovered that the accelerated aging of the gel is also correlated on the plastic chosen to mold the gel.

Cassettes are usually made of plastic comprising plasticizers, dispersants or other additives (as bisphenol A, polychlorinated naphtalene, benzalfehyde, etc), which can leak out and diffuse in the acrylamide gel matrix, affecting its stability and shelf life. Plastics contain also oxygen and elements that interfere with the free radicals generated by the oxido-reduction reaction generated by the ammonium persulfate and N,N,N′,N′-Tetramethylethylenediamine (TEMED), thereby distorting the polymerization of the acrylamide gel matrix. It was discovered that by limiting the charge in the plastic and establishing a chemical barrier between the plastic and the liquid composition, it prevents polymerization to cause distortion and lead to regular aging of the gel and flat and adhesive surface of the gel.

When the liquid composition is an acrylamide composition, uncharged plastics with a strong chemical barrier to prevent any reaction with the acrylamide composition, or the gel buffering solution, or the catalyzing reaction were selected to make the cassette 10. The plastic will not as well interact with the electric field during electrophoresis, which can create distorted migration. An evaluation of relative performance according to this aspect was conducted for each of the selected plastic and read as follows: Eastman SPECTAR copolyester™ PETG (+/−), EASTAR copolyesters™ AN004 (+++), DuraStar polymer™ MN611 (+), EASTAR copolyesters™ DN004 (++), EASTAR copolyesters™ DN011 (+++), Eastman TRITAN copolyester™ TX1001 (+++), EASTAR copolyesters™ EN067 (++). For each previous selection, the performance is better than that of SAN which is usually used. SAN (Styrene acrylonitrile resin) is a copolymer plastic consisting of styrene and acrylonitrile. Eastman SPECTAR copolyester™ PETG, EASTAR copolyesters™ AN004, DuraStar polymer™ MN611, EASTAR copolyesters™ DN004, EASTAR copolyesters™ DN011, Eastman TRITAN copolyester™ TX1001 and EASTAR copolyesters™ EN067 are product brands of Eastman Chemicals. Also, EASTAR copolyesters™ 6763, EASTAR copolyesters™ 21446, EASTAR PCTG copolyesters™ etc and all grades of these references and all plastics presenting a strong chemical barrier as used in cosmetic, pharmaceutical and packaging can be considered for such application.

Moreover, a coating was added to form a chemical barrier between the plastic and the acrylamide composition. The method for coating the plastic comprises the following steps:

Dipping in a silanic liquid, namely a Bind-Silane, or a silane Dipping recipe comprising:

600 ml methanol ;

135 ml distiled water ;

15 ml Glacial Acetic Acid ; and

45 ul Bind-Silane.

Rinsing twice in water and drying with tissue, air drying or air stream.

Optionally, coating the cassettes with a liquid glue.

This coating improves the adherence of gel to the cassette 10 surface upon which the gel is to be attached thereon.

The coating of the cassette 10 comprises a silanic layer coating the plastic. Optionally the coating comprises a glue layer coating the silanic layer. When using the cassette 10, the gel is adherent to the glue layer, thereby mechanically attached to the cassette 10.

The first shell 14 and the second shell 16 of the cassette 10 have a joint 23 between them. The shells 14 & 16 are optionally fixed together at the joint 23 with any procedures (i.e. ultrasonic welding) or any glues to removably attach together the two shells, optionally glues include Methylene Chloride or Loctite 5145 silicone glue among others.

Turning to the sealed cassette 12 on FIG. 1, it comprises a stopper 24 removably mounted onto the sealed cassette 12 to seal the second opening 22. Preferably, the stopper 24 comprises a mechanical layer for retaining the composition and a sticky layer covering a portion of the mechanical layer and stuck to the cassette for sealing the second opening 22.

A leak proof closure system to allow individual filling closures, namely the stopper 24, is made of a layer of a slightly sticky tape, tissue or wax, namely the mechanical layer to block the cassette opening (all along the base of the cassette) which is then dipped in a sealing liquid forming the sticky layer.

The mechanical layer is selected in the group consisting of: Wax sheet, as Sheet Wax No. 266, Thermo-Stable Adhesive-Coated (from Freeman), any adhesive tape as Masking tape, Electric tape, Scotch tape, Labeling tape, Filament tape, as well as non adhesive tapes as Teflon tape and Parafilm.

The sealing liquid is selected in the group consisting of: Melted wax, Was tested paraffinic wax, paraffinic wax+Zinsser Shellac, paraffinic wax+Venice turpentine, paraffinic wax+Vybar, paraffinic wax+stearic acid, Melted polyethylene in the wax, Varnish, Delta Ceramcoat mat varnish #1203, Nail polish, Nail varnish, Was tested Sally Hansen #3157, Varathan, Paint, Solubilized resin, Smooth cast molding agent (60D semi rigid), Plaid Mod Dodge # CS11201, and Glue with acrylic adhesive, methylene chloride, methyl methacrylate. (It was tested Loctite adhesive sealant 5145). The preferred method is using Freeman Sheet Wax # 266 & Varathan Diamond wood finish gloss varnish # 2500-61.

Such an effective sealing allows to envisioned cassettes with two opposite distal openings 20 & 22 where, in a molding position, the first opening 20 is on the top and the second opening 22 is on the bottom and which maximizes the distance between the opening 20 & 22, thereby maximizing efficiency of the analysis.

Returning now to the cassette 10 on FIG. 1, pegs 26 normally extend from the first shell 14 and abut to an internal surface 28 of the second shell 16 for keeping the distance 18 between the first shell 14 and the second shell 16.

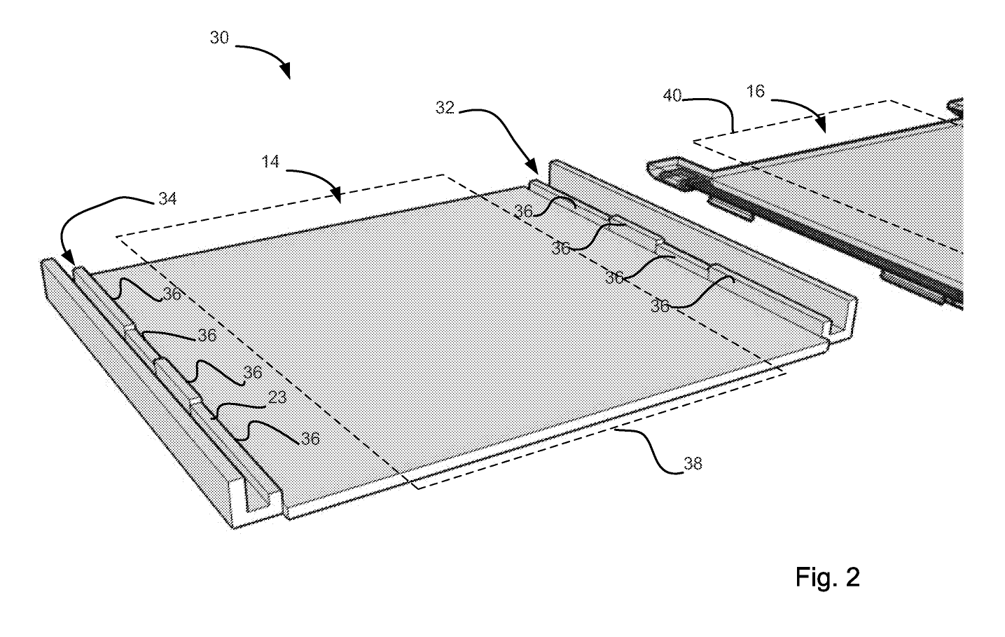

Now referring to FIG. 2, there is shown a cassette 30 according to another embodiment. The cassette comprises a first shell 14 and a second shell 16. The first shell 14 comprises two lateral banks 32 & 34 of aligned edges 36. The heights of the edges 36 according to a first main plan 38 of the first shell 14 are such that when the first shell 14 and the second shell 16 are mated together in a first respective position, as shown, a first distance, preferably 1.5 mm, is kept between the first shell 14 and the second shell 16 and when the first shell 14 and the second shell 16 are mated together in a second respective position (the second shell 16 pivoted of half a revolution in its second main plane 40), a second distance, preferably 1.5 mm, not shown, is kept between the first shell 14 and the second shell 16.

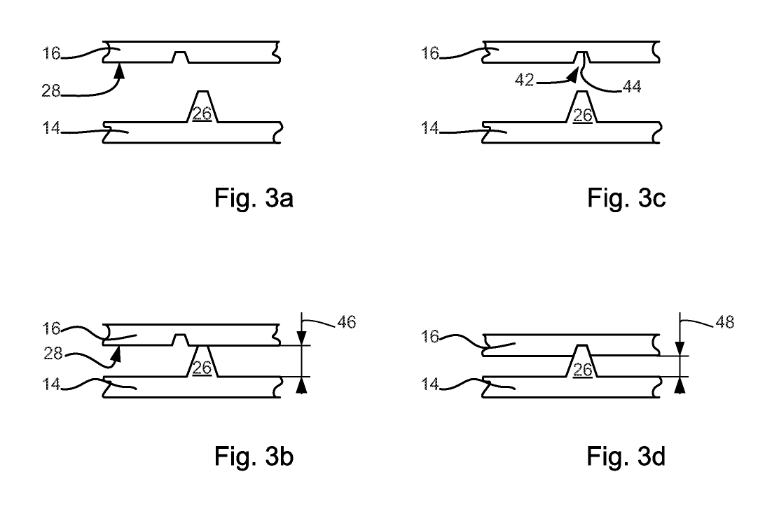

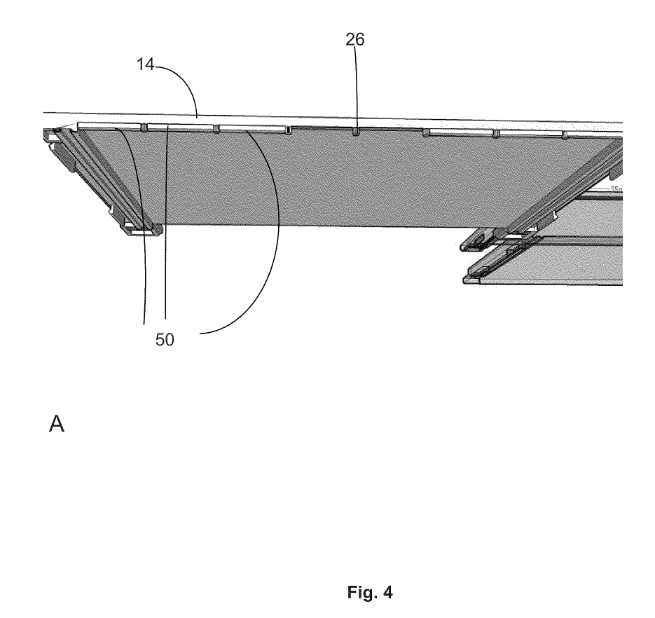

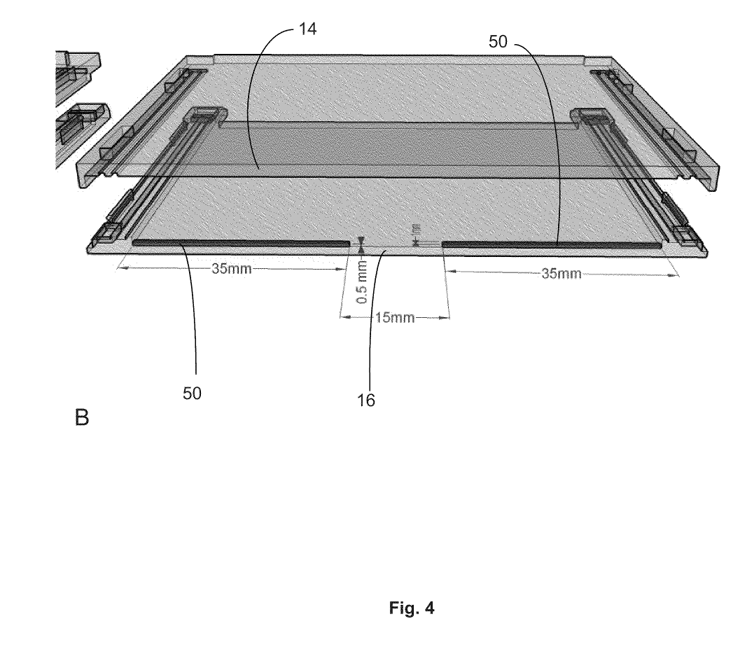

Turning to FIG. 3a-d, concurrently referred to, there are shown the first shell 14 and the second shell 16, in two different respective positions. The first shell 14 has a peg 26 normally extending from the first shell 14. The second shell 16 comprises an internal surface 28 having a cavity 42 with a bottom 44. On FIG. 3a and FIG. 3b, the shells 14 & 16 are mated in a first position; the peg 26 abuts to the internal surface 28 of the second shell 16 for keeping a first distance 46. On FIG. 3c and FIG. 3d, the shells 14 & 16 are mated in a second position (the second shell 16 pivoted of half a revolution in its second main plane 40), the peg 26 abuts to the cavity bottom 44 for keeping the second distance 48.

The base of the cassette 10 or 12 comprises a large opening which leaves the gel therein entirely exposed. The gel will normally not extrude itself from the cassette because of retention along the inner surfaces of the cassette 10 or 12. During or after electrophoresis, the gel often changes in proportions and move slightly. Also, during transportation, if there are several changes in temperature, pressure changes or vibrations, the gel can also move. Finally, in storage, while aging, the gel can also change in proportions. The change in proportions will often cause the gel to move towards the openings at the bottom or at the top of the cassette 10 or 12. When the gel expands or protrudes from the bottom opening of the cassette 10 or 12 it makes for a messy commercial product, and it may results in the gel being damaged since it is fragile. This is a strong irritant for the end users.

To alleviate the problem of gels moving out of the cassettes 10 or 12, different configurations of cassettes 10 or 12 were tested to include gel retaining members 50 to retain the gel matrix and prevent it from moving out of the cassette 10 or 12. The tested configurations of gel retaining members 50 will not be affecting the filling of the cassette if filling from the bottom is attempted. They will also not be affecting the electric flow and allow a good electrophoresis without affecting the migration path, and/or create distortion in the movement of the material being separated in this gel matrix.

In the case of a unitary body cassette 10 or 12 (i.e. a cassette not made of two shells, but as a single unitary body), the gel retaining members 50 may take the form of one or several walls extending from the walls of the cassette 10 or 12, to partially obstruct the bottom opening. In the case of cassettes 10 or 12 with two shells, the gel retainining member 50 may be located on one shell or on both shells.

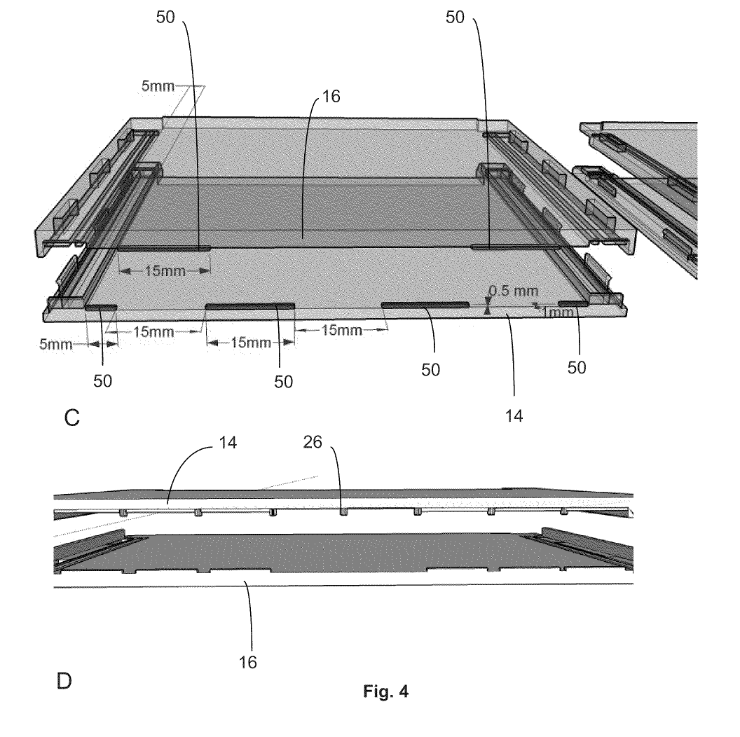

Now referring to FIG. 4a -d, there are shown the first shell 14 and the second shell 16, alone or in juxtaposed relationship. The first shell may have pegs 26 (FIG. 4a) extending from the first shell 14, and a gel retaining member 50 is also extending from the first shell 14. As shown, the gel retaining members 50 are inserted between the peg 26, and an opening is left towards the central region of the shell 14. The gel retaining members will therefore only partially obstruct the bottom opening. The gel retaining member 50 may also extend from a first shell 14 that does not comprise peg 26 (FIG. 4b). The gel retaining members 50 may also be extending from both the first shell 14 and the second shell 16 at the same time. When the shells are joined to form a sealed cassette 10 or 12, the plurality of gel retaining members 50 form a continuous wall of retaining members 50 that prevent the gel from coming out of the cassette 10 or 12. This may be achieved by having gel retaining members on both the first shell 14 and second shell 16 in a staggered way, so that the gel retaining members 50 will insert in between each other and form a wall when the two shells are joined (FIG. 4c). This may also be achieved by having the gel retaining members 50 in a facing relationship on the first shell 14 and the second shell 16, so that when the two shells are joined, the gel retaining members 50 will form a wall that will prevent the gel from coming out of the cassette 10 or 12 (FIG. 4d). Although FIG. 4d shows the first shell having pegs 26, the pegs 26 may or may not be included to achieve the desired gel retaining function.

Adding gel retaining members such as the walls shown in FIG. 4 from about 50% to about 99% of the bottom opening, from one side of the cassette 10 or 12 or from both side of the cassette 10 or 12 will maintain the gel matrix in proper position and prevent the gel from coming out of the cassette after manipulation or use of the cassette 10 or 12, and will not disturb the electric flow and migration of the samples being separated therein.

Another irritant for the end-users is the fact that well separators are often likely to move when the gel wells are free of forming combs and are open to all external forces. The separators can then be displaced by strong hit, movements and pressure on the cassette. Also, when the gel running buffer is added to the electrophoresis chamber, the liquid flow can displace the well separators.

To alleviate the problem of the well separators being displaced, different configurations of cassettes were tested to include well separator receiving grooves 60. The well separator receiving grooves 60 are small grooves in the material of the cassette (e.g. the plastic) that are positioned at the level of the separators, where the acrylamide (or other polymer mixture) can fill and polymerize therein, creating a “hook” holding the well separator in proper position.

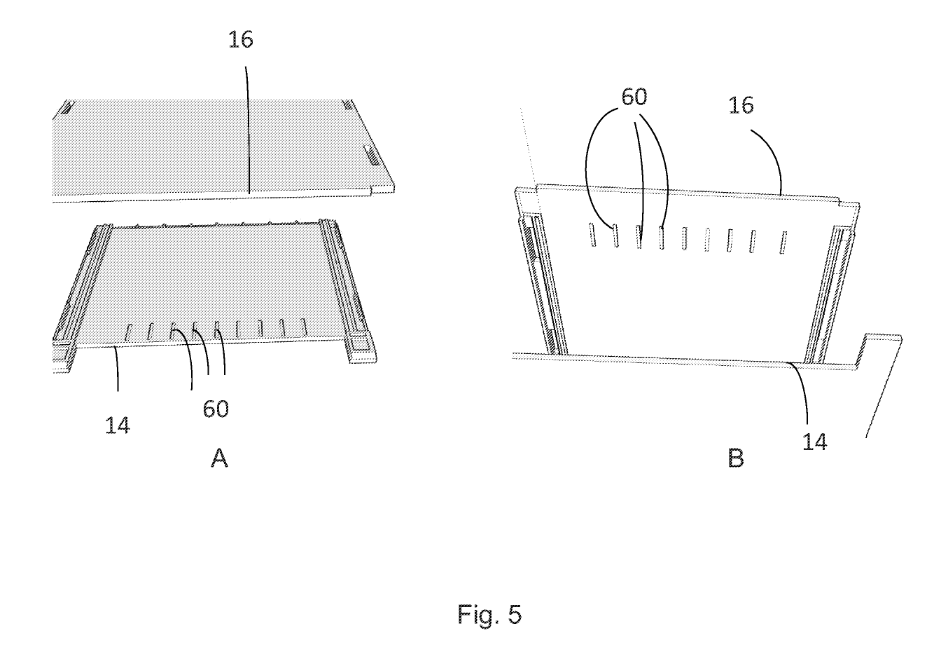

Now referring to FIG. 5a-b, the well separator receiving grooves 60 may be on the first shell 14 only (FIG. 5a), on the second shell 16 (FIG. 5b), or both shells 14 and 16 may have the well separator receiving groove 60 to effect an enhanced holding of the well separators.

While preferred embodiments of the invention have been described above and illustrated in the accompanying drawings, it will be evident to those skilled in the art that modifications may be made therein without departing from the essence of this invention. Such modifications are considered as possible variants comprised in the scope of the invention.

1. A sealed cassette for molding a composition used for biological analysis, the sealed cassette comprising:
a cassette for receiving the composition, the cassette having:
diametrically opposed first opening and second opening; and
a stopper removably mounted onto the cassette to seal the first or second opening.

2. The sealed cassette of claim 1 wherein the stopper comprises:
a mechanical layer for retaining the composition; and
an adhesive layer covering a portion of the mechanical layer and adhering to the cassette for sealing the second opening.

3. The sealed cassette of claim 1, further comprising a gel retaining member.

4. The sealed cassette of claim 3, wherein the gel retaining member is at least one wall partially obstructing the first or second opening.

5. The sealed cassette of claims 3, wherein the at least one wall is obstructing from about 50% to about 99% of the first or second opening.

6. The sealed cassette of claim 1, further comprising at least one well separator receiving groove therein, adapted to receive and hold a well separator.

7. The sealed cassette of claim 1, further comprising at least two well separator receiving grooves therein, facing each other and adapted to receive and hold a well separator.

8. The sealed cassette of claim 1, wherein the sealed cassette comprises a first shell and a second shell removably fixed together.

9. The sealed cassette of claim 8, wherein said first shell and said second shell are removably fixed together using welding or gluing.

10. A cassette for molding a composition used for biological analysis, the cassette comprising:
a first shell; and
a second shell;
wherein the first shell and the second shell are adapted for mating together in a first respective position keeping a first distance between the first shell and the second shell and for mating together in a second respective position keeping a second distance between the first shell and the second shell, and
wherein the first and second shells, when mated together, define a cavity adapted to receive the composition having diametrically opposed first and second opening.

11. The cassette of claim 10 wherein the first shell comprises at least one peg and the second shell comprises an internal surface having at least one cavity with a bottom;
wherein when the shells are mated in the first position, the at least one peg abuts to the internal surface of the second shell for keeping the first distance; and
wherein when the shells are mated in the second position, the at least one peg abuts to the at least one cavity bottom for keeping the second distance.

12. The cassette of of claim 10, further comprising a gel retaining member.

13. The cassette of claim 12, wherein the gel retaining member is at least one wall obstructing the first or second opening.

14. The cassette of claim 12, wherein the obstruction of the first or second opening is from about 50% to about 99%.

15. The cassette of claim 13, wherein said at least one wall is attached to any one of the first shell or the second shell.

16. The cassette of claim 10, further comprising at least one well separator receiving groove therein, adapted to receive and hold a well separator.

17. The cassette of claim 10, further comprising at least two well separator receiving grooves therein, diametrically opposed and adapted to receive and hold a well separator.

18. The cassette of claim 10, wherein said first shell and the second shell are removably fixed together.

19. The cassette of claim 18, wherein said first shell and the second shell are removably fixed together using welding or gluing.

20. A cassette for molding an acrylamide composition used for biological analysis, the cassette made of a plastic chosen from Eastman SPECTAR copolyester™ PETG, EASTAR copolyesters™ AN004, DuraStar polymer™ MN611, EASTAR copolyesters™ DN004, EASTAR copolyesters™ DN011, Eastman TRITAN copolyester™ TX1001,EASTAR copolyesters™ EN067, EASTAR copolyesters™ 6763, EASTAR copolyesters™ 21446 and EASTAR PCTG copolyesters™.
